(19) United States
(12) Patent Application Publication
(10) Pub. No.: US 2025/0206163 A1
(43) Pub. Date: Jun. 26, 2025

(54) ACTIVE RIPPLE ENERGY STORAGE CIRCUIT VIA STANDALONE BOOSTER MODULE CONNECTED WITH HIGH VOLTAGE DC BUS

(71) Applicant: FORD GLOBAL TECHNOLOGIES, LLC, Dearborn, MI (US)

(72) Inventor: Mohamed Elshaer, Canton, MI (US)

(21) Appl. No.: 18/393,895

(22) Filed: Dec. 22, 2023

(51) Int. Cl. B60L 53/22; H02M 1/42; H02M 3/335

(52) U.S. Cl. CPC B60L 53/22; B60L 2210/14; B60L 2210/30; H02M 1/4208; H02M 3/33573

(57) ABSTRACT

An automotive power system has a battery current control module including a bidirectional power factor correction circuit and an isolated DC/DC converter connected between a bus and the bidirectional power factor correction circuit. The system further has a traction battery connected with the bus, and a booster module including a capacitor connected with the bus between the battery current control module and traction battery.

### TECHNICAL FIELD

This disclosure relates to automotive power systems.

### BACKGROUND

An automotive vehicle may use electrical energy from a traction battery to power an electric machine. The electric machine may convert this electrical energy to mechanical energy to propel the vehicle. The automotive vehicle may include various power electronics equipment to condition and store electrical energy.

### SUMMARY

A vehicle has a power system including a traction battery, a battery current control module, a booster module, and a bus electrically connecting the traction battery, battery current control module, and booster module. The vehicle also has a controller that, while the battery current control module is delivering AC current to the bus from an AC source, operates the booster module to alternately store energy from the bus and discharge energy to the bus such that the traction battery receives direct current from the bus.

A method includes, while a battery current control module is delivering AC current to a bus from an AC source, operating a booster module such that a capacitor thereof alternately stores energy from the bus and discharges energy to the bus resulting in a traction battery receiving DC current from the bus.

An automotive power system has a bus, a battery current control module, including a bidirectional power factor correction circuit and an isolated DC/DC converter connected between the bus and bidirectional power factor correction circuit, connectable with an AC source, a traction battery connected with the bus, and a booster module, including a capacitor connected with the bus between the battery current control module and traction battery, connectable with a DC charge source.

### BRIEF DESCRIPTION OF THE DRAWINGS

FIG. 1 is a schematic diagram of battery current control module circuitry with added active ripple energy storage circuitry.

FIG. 2 is a schematic diagram of a boost circuit that charges an 800V traction battery from a 400V DC fast charge station.

FIG. 3 is a block diagram of a high voltage charging architecture of an electric vehicle configured for charging a traction battery using power from an AC grid, a 400V DC fast charge station, and an 800V DC fast charge station.

FIGS. 4A, 4B, 4C, and 4D show typical waveforms for the AC grid voltage, battery current control module current, booster current, and traction battery current, respectively.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Battery current control modules (BCCMs) play a role in managing the flow of electric current to and from the traction battery. BCCMs function as control units that interface between the traction battery, the charging system, and the electrical loads. They monitor and control various parameters such as battery state of charge, voltage, and temperature, and based on this information, they manage the flow of current to the traction battery. BCCMs may facilitate charging control by overseeing the charging process of the traction battery, and managing the voltage and current supplied by the charging system. By monitoring the traction battery's state of charge and adjusting the charging parameters accordingly, BCCMs attempt to ensure the traction battery receives the appropriate level of charge to maintain performance. Similarly, BCCMs may be responsible for discharging control. They can manage the current output from the traction battery to the electrical loads in the vehicle. By controlling the current flow, BCCMs may ensure a controlled supply of power to the various electrical components and systems. BCCMs may also implement various measures for the traction battery. For instance, they may monitor battery temperature to prevent overheating. They may also detect over voltage or under voltage situations and implement measures to preclude short circuits or excessive current draw. BCCMs may feature diagnostic capabilities. These modules can monitor the health and performance of the battery system. They can log codes and provide diagnostic information, facilitating maintenance.

Communication interfaces are often incorporated into BCCMs. These interfaces, such as Controller Area Network (CAN) or LIN (Local Interconnect Network), allow BCCMs to exchange information with other vehicle systems, including the engine control unit or the body control module. This enables coordinated operation and integrated control across various vehicle functions. BCCMs can receive commands or instructions from other control units and adjust current flow accordingly.

The electrolytic capacitor bank is considered one of the large components in the BCCM. It can consume almost 20% of the overall BCCM package volume. To help increase the BCCM's power density, an active ripple energy storage circuit can be added, which is estimated to reduce the overall electrolytic capacitor bank size by as much as 70%.

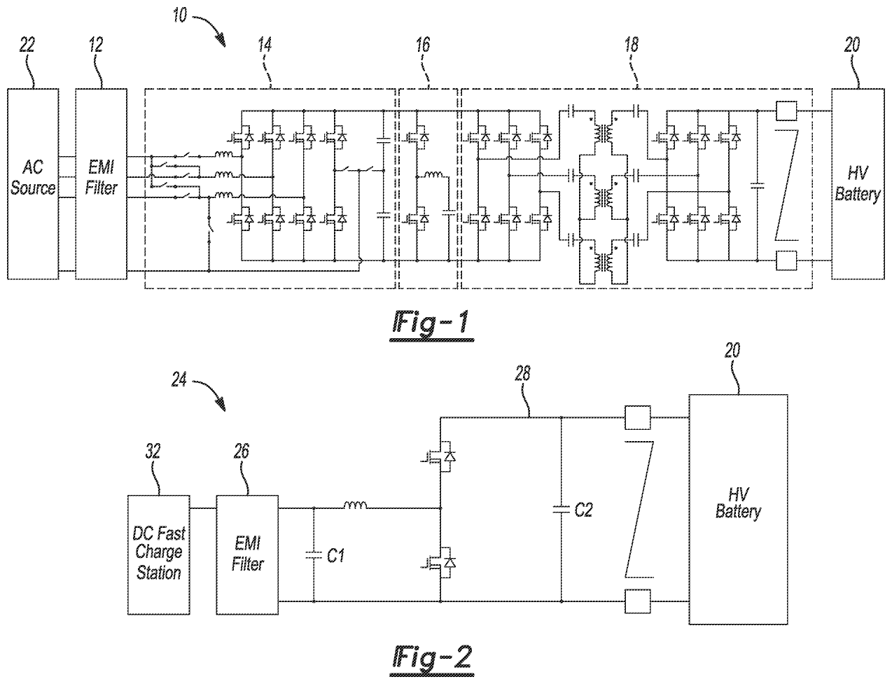

Referring to FIG. 1, an onboard charger circuitry topology 10 includes an electromagnetic interference filter 12, a bidirectional power factor correction circuit 14 (e.g., a single/three phase bidirectional totem pole power factor correction circuit), an active ripple energy storage circuit 16, and an isolated high voltage DC/DC converter 18. The bidirectional power factor correction circuit 14 is connected between the electromagnetic interference filter 12 and active ripple energy storage circuit 16. The active ripple energy storage circuit 16 is connected between the bidirectional power factor correction circuit 14 and isolated high voltage DC/DC converter 18. The isolated high voltage DC/DC converter 18 is connected between the active ripple energy storage circuit 16 and a traction battery 20. The topology 10 is connected with an AC source 22 via the electromagnetic interference filter 12. Power from the AC source 22 may thus charge the traction battery 20.

Components associated with the active ripple energy storage circuit 16 may introduce certain issues. The reduction in package size associated with incorporating the active ripple energy storage circuit 16 may not be sufficient to justify introduction of these certain issues. Here, a booster module is proposed to perform the function of the active ripple energy storage circuit 16.

Referring to FIG. 2, a booster circuit topology 24 includes an electromagnetic interference filter 26 and a booster circuit 28. The booster circuit 28 is connected between the electromagnetic interference filter 26 and the traction battery 20. The topology 24 is connected with a 400V DC fast charge source 32 via the electromagnetic interference filter 26. Power from the 400V DC fast charge source 32 may thus charge the traction battery 20.

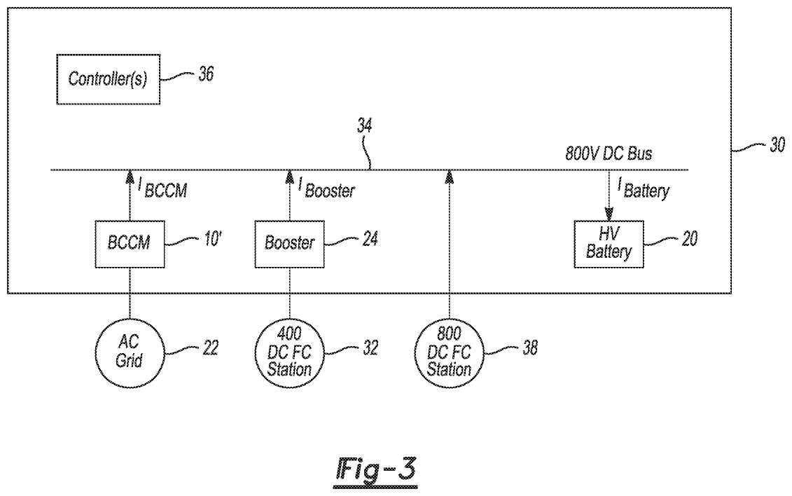

As mentioned above, an implementation of an active ripple energy storage circuit using a booster module sitting on a DC bus is proposed. Referring to FIG. 3, a vehicle 30 includes the topology 10′, traction battery 20, topology 24, high voltage bus 34, and controller 36. The topology 10′ is the topology 10 with the active ripple energy storage circuit 16 omitted, and the bidirectional power factor correction circuit 14 directly connected with the isolated high voltage DC/DC converter 18. The topologies 10′, 24 are connected with the traction battery 20 via the high voltage bus 34. The controller 36 is in communication with and/or exerts control over the components of FIG. 3.

The AC source 22 is connectable with the topology 10′ via the electromagnetic interference filter. The 400V DC fast charge source 32 is connectable with the topology 24 via the electromagnetic interference filter 26. An 800V DC fast charge station 38 is connectable with the high voltage bus 34.

In a typical implementation, the onboard booster circuit is not utilized while charging the traction battery from the AC grid. Such is not the case here. The topology 24 is used to implement the energy storage function. When the traction battery 20 is being charged from the AC source 22, the input to the booster module 24 would be disconnected from the 400V DC fast charge station 32 and unloaded. The high voltage DC bus 34 would likewise be disconnected from the 800V DC fast charge station 38. The booster module 24 is controlled via the controller 36 to store energy and discharge energy in its input capacitor C1. The capacitor C1 is expected to see a ripple voltage proportional to the power delivered to the traction battery 20. The current generated by the booster module 24 is synchronized with the AC grid voltage from the AC source 22. The booster module 24 is controlled via the controller 36 to generate an AC current that is proportional to and synchronized with the AC current generated by the BCCM 10′. The booster module AC current is controlled via the controller 36 to minimize the ripple current delivered to the traction battery 20. The current generated by the booster module 24 has an average value of zero.

The bidirectional power factor correction circuit 14 converts AC to DC, synchronizing input current with AC voltage for a unity power factor. It produces DC with a low-frequency ripple, excluding the active ripple energy storage and utilizing output capacitors only for filtering purposes, not for energy storage. The BCCM converter's output current varies directly with the AC voltage, ensuring an instantaneous power match between AC input and DC output. This converter charges the traction battery 20 with a current that mirrors the AC voltage, which falls to zero as the AC input does. The booster circuit 28, meanwhile, adjusts the voltage across capacitor C1 to yield an AC current, harmonizing the BCCM's output to closely resemble a DC current for the traction battery 20 and managing low-frequency ripple according to C1's size and voltage. The booster circuit 28 is designed for bidirectional power, capable of rerouting excess current from the BCCM 10′ back to C1, and vice versa, to ensure uninterrupted battery charging with minimal ripple. It controls C1's voltage within a predefined range. By utilizing the bottom switch (e.g., metal-oxide-semiconductor field-effect-transistor) as an active switch and the top switch (e.g., metal-oxide-semiconductor field-effect-transistor) as a synchronous rectifier, the circuit 28 functions similarly to a boost converter, effectively increasing the voltage from C1 to the level required by the traction battery 20.

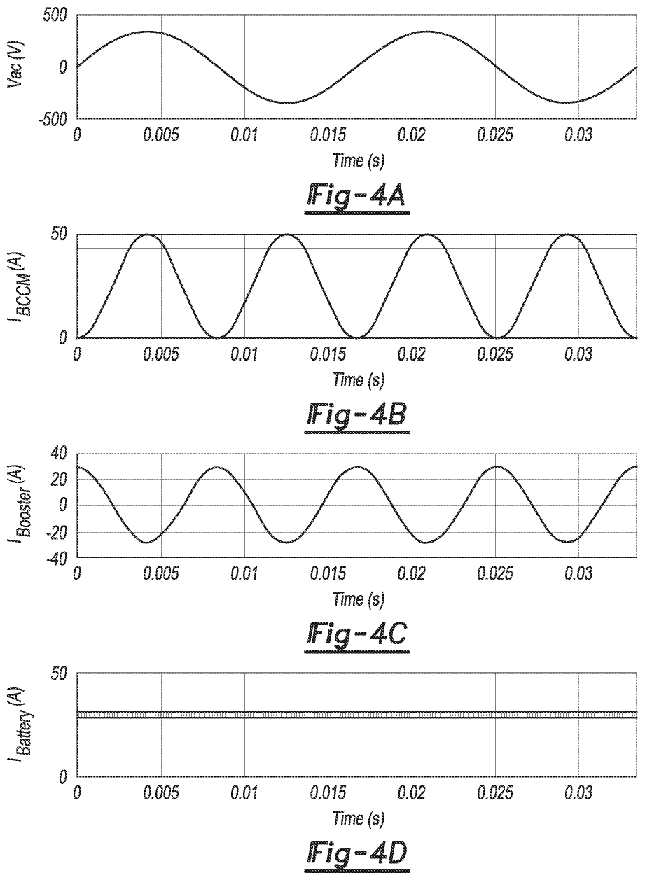

Referring to FIGS. 4A, 4B, 4C, and 4D, the BCCM 10′ in this example does not have an energy storage element. Hence, its output current is proportional to the AC grid's instantaneous power. This means that when the AC grid voltage is zero, the output current of the BCCM 10′ is zero. The booster module 24 is operated to absorb the ripple current by charging and discharging its input capacitor C1. Hence, the net current delivered to the traction battery 20 is DC.

It is also possible to add a small energy storage capacitor in the BCCM 10′ such that the BCCM output current does not fall to zero during the AC line voltage zero crossing. This will reduce the burden on the booster module 24: The average energy stored in the capacitor C1 in one AC line cycle is reduced.

The BCCM module 10′ is designed to operate normally even if the booster module 24 is not functional. The booster module 24 aims to reduce the low-frequency ripple delivered to the traction battery 20 while charging from the AC source 22.

Since the booster module 24 is implemented as a separate module, communication between the BCCM 10′ and booster module 24 may be established in several ways. The BCCM 10′ may send information about grid voltage, frequency, and phase to the booster module 24. A controller in the booster module 24 derives the reference current that minimizes the low-frequency ripple seen by the traction battery 20 for a given charge current in known fashion. The BCCM 10′ may produce an analog or digital signal for the reference current fed to the booster controller. The BCCM 10′ may communicate reference current signals to the booster module 24 via digital communication methods such as CAN, LIN, I2C, Ethernet, etc., as suggested above.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. A vehicle, for example, may not include a port configured to receive charge from an 800V DC fast charge station. Other BCCM and booster module architectures are also contemplated, etc.

The words used in the specification are words of description rather than limitation, and it is understood that various changes may be made without departing from the spirit and scope of these disclosed materials. The terms “controller” and “controllers,” for example, can be used interchangeably herein as the functionality of a controller can be distributed across several controllers/modules, including battery current control modules and booster modules, which may all communicate via the techniques described above.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a power system including a traction battery, a battery current control module, a booster module, and a bus electrically connecting the traction battery, battery current control module, and booster module; and
a controller programmed to, while the battery current control module is delivering AC current to the bus from an AC source, operate the booster module to alternately store energy from the bus and discharge energy to the bus such that the traction battery receives direct current from the bus.

2. The vehicle of claim 1, wherein the AC current is proportional to an instantaneous power of the AC source such that when a voltage of the AC source has a value of zero, the AC current has a value of zero.

3. The vehicle of claim 1, wherein current associated with operation of the booster module has an average value of zero.

4. The vehicle of claim 1, wherein the battery current control module is configured to communicate information related to the AC source to the booster module.

5. The vehicle of claim 1, wherein the battery current control module includes a bidirectional power factor correction circuit and an isolated DC/DC converter.

6. The vehicle of claim 5, wherein the bidirectional power factor correction circuit is a bidirectional totem pole power factor correction circuit.

7. The vehicle of claim 5, wherein the isolated DC/DC converter includes a transformer, a switching bridge, and a switch bank connected between the transformer and switching bridge.

8. A method comprising:
while a battery current control module is delivering AC current to a bus from an AC source, operating a booster module such that a capacitor thereof alternately stores energy from the bus and discharges energy to the bus resulting in a traction battery receiving DC current from the bus.

9. The method of claim 8, wherein the AC current is proportional to an instantaneous power of the AC source such that when a voltage of the AC source has a value of zero, the AC current has a value of zero.

10. The method of claim 8, wherein current associated with the operating has an average value of zero.

11. The method of claim 8 further comprising communicating information related to the AC source to the booster module.

12. An automotive power system comprising:
a bus;
a battery current control module, including a bidirectional power factor correction circuit and an isolated DC/DC converter connected between the bus and bidirectional power factor correction circuit, configured to be connected with an AC source;
a traction battery connected with the bus; and
a booster module, including a capacitor connected with the bus between the battery current control module and traction battery, configured to be connected with a DC charge source.

13. The automotive power system of claim 12 further comprising a controller programmed to, while the battery current control module is delivering AC current from the AC source to the bus, operating the booster module to alternately store energy from the bus to the capacitor and discharge energy from the capacitor to the bus such that the traction battery receives DC current from the bus.

14. The automotive power system of claim 13, wherein the AC current is proportional to an instantaneous power of the AC source such that when a voltage of the AC source has a value of zero, the AC current has a value of zero.

15. The automotive power system of claim 12, wherein current associated with operation of the booster module has an average value of zero.

16. The automotive power system of claim 12, wherein the battery current control module is configured to communicate information related to the AC source to the booster module.

17. The automotive power system of claim 12, wherein the isolated DC/DC converter includes a transformer, a switching bridge, and a switch bank connected between the transformer and switching bridge.
